(19) United States
(12) Patent Application Publication
(10) Pub. No.: US 2022/0104150 A1
(43) Pub. Date: Mar. 31, 2022

(54) USER EQUIPMENT AND METHOD OF WIRELESS COMMUNICATION OF SAME

(71) Applicant: GUANGDONG OPPO MOBILE TELECOMMUNICATIONS CORP., LTD., Dongguan (CN)

(72) Inventors: Huei-Ming Lin, South Yarra (AU); Zhenshan Zhao, Dongguan (CN); Qianxi Lu, Dongguan (CN)

(21) Appl. No.: 17/545,757

(22) Filed: Dec. 8, 2021

Related U.S. Application Data
(63) Continuation of application No. PCT/CN2019/100239, filed on Aug. 12, 2019.

(51) Int. Cl. H04W 52/36

(52) U.S. Cl. CPC H04W 52/367

(57) ABSTRACT

A user equipment and a method of wireless communication of same are provided. The method includes being configured with a first configuration of a set of transmit (Tx) power levels and transmitting, to another user equipment, one of Tx power levels from the first configuration of the set of Tx power levels, wherein the set of Tx power levels provides a full range of output power for the user equipment.

### CROSS-REFERENCE TO RELATED APPLICATION

This application is a continuation of International Application No. PCT/CN2019/100239, filed on Aug. 12, 2019, the entire contents of which are incorporated herein by reference.

### BACKGROUND OF DISCLOSURE

### 1. Field of the Disclosure

The present disclosure relates to the field of communication systems, and more particularly, to a user equipment and a method of wireless communication of same.

### 2. Description of the Related Art

In the evolution of sidelink (SL) technologies being developed under 3rd generation partnership project (3GPP) for direct communication from one user equipment (UE) to another UE wirelessly, there are increasing demands, variety of advanced services, and applications to be supported such as augmented reality (AR)/virtual reality (VR) gaming, autonomous driving for vehicles, sensor data sharing and emergency rescue in disaster areas. Traditionally for basic road safety and public safety use cases, sidelink (SL) transmission power output for a UE is usually set at a level that is as large as possible in order to reach far distances and be heard by as many UEs as possible. For some of the advanced use cases, direct SL communication is confined within a group of users that are in close proximity to each other or just between two nearby UEs. As such, their transmission output powers could be small and at the same time varying dynamically adapting to the required communication range, data message size, group size, and wireless channel conditions.

In order for a transmit UE (Tx-UE) to determine appropriate output power level for data transmission, it currently relies on a receiver UE (Rx-UE) to perform measurements on sidelink channel condition and feedback measurement reports (e.g., SL reference signal received power (SL-RSRP)) to the Tx-UE for it to calculate SL pathloss. Then combining with Tx power that it had previously used for the past transmissions, the Tx-UE determines new Tx power and/or modulation and coding scheme (MCS) levels for future transmission(s) until new SL-RSRP feedback is received from the Rx-UE. Under a such Tx power determination scheme, it avoids the need for the Tx-UE to indicating/informing the Rx-UE the actual transmission power level every time, and thus reducing the payload size for SL control information (SCI). However, this scheme is suitable only for SL unicast communication as it assumes prior establishment of radio resource control (RRC) connection between the Tx and Rx UEs over the sidelink/PC5 interface. As such, the deficiency lies within the extra signaling exchange between the UEs and feedback delay for the SL-RSRP reports.

Furthermore, since this scheme requires prior measurement reporting from the Rx-UE to the Tx-UE, it is then not possible for the Rx-UE to first determine an appropriate power level for sending its physical sidelink feedback channel (PSFCH) and thus creating a risk of introducing interference to other UE's PSFCH transmissions or being interfere by others. In another operating scenario such as SL broadcast communication where SL channel sensing is first performed by a UE before selecting SL resources for its transmission, if the measured SL-RSRP from a unicast UE's transmission is small and the transmission power is not indicated as part of SCI, the broadcast UE may wrongly determine during its resource selection procedure that the unicast UE is far away and thus interpret that it is safe to reuse the same SL resource for its own transmission. As a result, causing Tx collisions/interference to the unicast session.

### SUMMARY

An object of the present disclosure is to propose a user equipment and a method of wireless communication of same capable of providing less signaling message exchange, more applications, use cases, and thus greater flexibility.

In a first aspect of the present disclosure, a user equipment for wireless communication includes a memory, a transceiver, and a processor coupled to the memory and the transceiver.

The processor is configured to be configured with a first configuration of a set of transmit (Tx) power levels and control the transceiver to transmit, to another user equipment, one of Tx power levels from the first configuration of the set of Tx power levels, wherein the set of Tx power levels provides a full range of output power for the user equipment.

In a second aspect of the present disclosure, a method of wireless communication of a user equipment includes being configured with a first configuration of a set of transmit (Tx) power levels and transmitting, to another user equipment, one of Tx power levels from the first configuration of the set of Tx power levels, wherein the set of Tx power levels provides a full range of output power for the user equipment.

In a third aspect of the present disclosure, a terminal device includes a processor and a memory configured to store a computer program. The processor is configured to execute the computer program stored in the memory to perform the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a user equipment (UE) for wireless communication and another UE in a communication network system according to an embodiment of the present disclosure.

FIG. 2 is a flowchart illustrating a method of wireless communication of a user equipment according to an embodiment of the present disclosure.

FIG. 3 is a schematic diagram of exemplary illustration of a set of sidelink Tx power levels according to an embodiment of the present disclosure.

FIG. 4 is a schematic diagram of exemplary illustration of a set of sidelink Tx power levels according to an embodiment of the present disclosure.

FIG. 5 is a schematic diagram of exemplary illustration of a set of sidelink Tx power levels according to an embodiment of the present disclosure.

FIG. 6 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Based on the above analysis and identified deficiencies, it is reasonable for a transmit user equipment (Tx-UE) to directly indicate its transmission power level to others in sidelink communications to avoid interference. To do this, a straight forward method is to include UE's SL transmission power level as part of sidelink control information (SCI) when transmitting physical sidelink control channel (PSCCH).

According to the existing reference signal received power (RSRP) reporting, there are currently 98 values that a UE can use to indicate its measured RSRP levels for feedback. To fully represent all of these values, it will require a SCI parameter of 7 bits. In long term evolution (LTE) SL communication, a SCI format has up to around 40 bits. Adding another 7 bits to the SCI will have significant impact/degradation to the control decoding performance, resulting in reduced reliability and smaller coverage, and hence undesirable.

In some embodiments of the present disclosure, for the present inventive sidelink Tx power management and signaling method, it aims to mitigate the described deficiency problems of signaling exchange and processing delay from relying on a receiver UE (Rx-UE) to feedback channel measurement reports (SL-RSRP) to a Tx-UE for calculating pathloss and deriving new transmission power settings. In order to achieve these, it is proposed for a Tx-UE to explicitly indicate its transmission output power or power spectrum density (PSD) level as part of SCI according to a set of (pre-)configured or pre-determined range of Tx power values while reducing the indication payload size (number of bits in SCI) at the same time. By doing so, UEs receiving and successfully decoding the SCI transmission would be able to directly calculate pathloss for the Tx-Rx link. Subsequently, the calculated pathloss is used by the Rx-UE to determine appropriate Tx output power level for sending its data/feedback messages back to the Tx-UE, or the pathloss is taken into account during its resource selection procedure to avoid Tx collision and creating interference.

In some embodiments of the present disclosure, at least one of following benefits of adopting the newly invented SL transmission power management and indication method is as follows. 1. Faster adaptation of transmission output power to changing channel condition without relying on measurement feedback reports from the Rx-UE. 2. Minimizing impact to the link performance from directly indicating Tx power level in SCI with reduced payload size, while still maintaining the full range of Tx power. 3. No RRC connection is required for a Rx-UE to directly calculate pathloss and determine its transmission power, and therefore, the proposed scheme provides more flexibility in greater range of use cases.

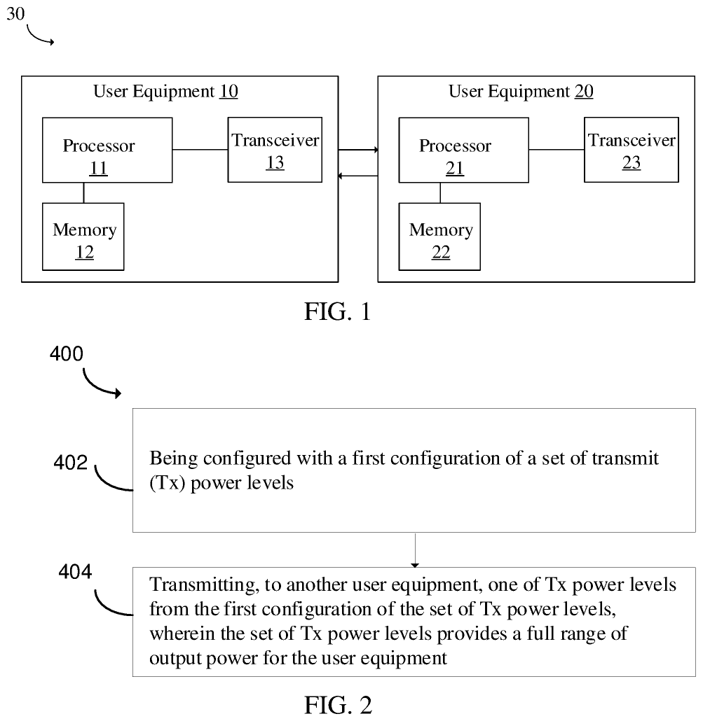

FIG. 1 illustrates that, in some embodiments, a user equipment (UE) 10 for wireless communication and another UE 20 in a communication network system 30 according to an embodiment of the present disclosure are provided. The communication network system 30 includes the UE 10 and the another UE 20. The UE 10 may include a memory 12, a transceiver 13, and a processor 11 coupled to the memory 12, the transceiver 13. The another UE 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals.

When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) Release 16 and beyond. UEs are communicated with each other directly via a sidelink interface such as a PC5 interface. Some embodiments of the present disclosure relate to sidelink communication technology in 3GPP NR release 16 and beyond.

In some embodiments, the processor 11 is configured to be configured with a first configuration of a set of transmit (Tx) power levels and control the transceiver 13 to transmit, to another user equipment 20, one of Tx power levels from the first configuration of the set of Tx power levels, wherein the set of Tx power levels provides a full range of output power for the user equipment 10.

In some embodiments, the first configuration of the set of Tx power levels is network configured or pre-configured. In some embodiments, a number of Tx power levels is flexibly configured to represent the full range of output power allowed for the user equipment 10.

In some embodiments, a range of output power value per Tx power level is flexibly configured.

In some embodiments, the one of the Tx power levels from the first configuration of the set of Tx power levels is provided as part of sidelink control information (SCI) from the transceiver 13 to the another user equipment 20.

In some embodiments, the processor 11 is configured to be configured with a second configuration to restrict the set of Tx power levels, and the transceiver 13 is configured to transmit, to the another user equipment 20, the second configuration.

In some embodiments, the second configuration is confined within a specific range of Tx power levels from the first configuration.

In some embodiments, the second configuration is one of a specific set of Tx power levels, a specific range of Tx power levels, a minimum level of Tx power levels, and a maximum level of Tx power levels.

In some embodiments, the second configuration is network configured or pre-configured.

In some embodiments, the second configuration is provided via a radio resource control (RRC) signaling from the transceiver 13 to the another user equipment 20.

In some embodiments, when the first configuration and the second configuration are network configured or pre-configured, the second configuration is provided together with the first configuration via a same information element (IE) or separate from the first configuration via a different IE.

FIG. 2 illustrates a method 400 of wireless communication of a UE according to an embodiment of the present disclosure.

The method 400 includes: a block 402, being configured with a first configuration of a set of transmit (Tx) power levels, and a block 404, transmitting, to another user equipment, one of Tx power levels from the first configuration of the set of Tx power levels, wherein the set of Tx power levels provides a full range of output power for the user equipment.

In some embodiments, the first configuration of the set of Tx power levels is network configured or pre-configured.

In some embodiments, a number of Tx power levels is flexibly configured to represent the full range of output power allowed for the user equipment.

In some embodiments, a range of output power value per Tx power level is flexibly configured.

In some embodiments, the one of the Tx power levels from the first configuration of the set of Tx power levels is provided as part of sidelink control information (SCI) from the user equipment to the another user equipment.

In some embodiments, the method further includes being configured with a second configuration to restrict the set of Tx power levels and transmitting, to the another user equipment, the second configuration.

In some embodiments, the second configuration is confined within a specific range of Tx power levels from the first configuration.

In some embodiments, the second configuration is one of a specific set of Tx power levels, a specific range of Tx power levels, a minimum level of Tx power levels, and a maximum level of Tx power levels.

In some embodiments, the second configuration is network configured or pre-configured.

In some embodiments, the second configuration is provided via a radio resource control (RRC) signaling from the user equipment to the another user equipment.

In some embodiments, when the first configuration and the second configuration are network configured or pre-configured, the second configuration is provided together with the first configuration via a same information element (IE) or separate from the first configuration via a different IE.

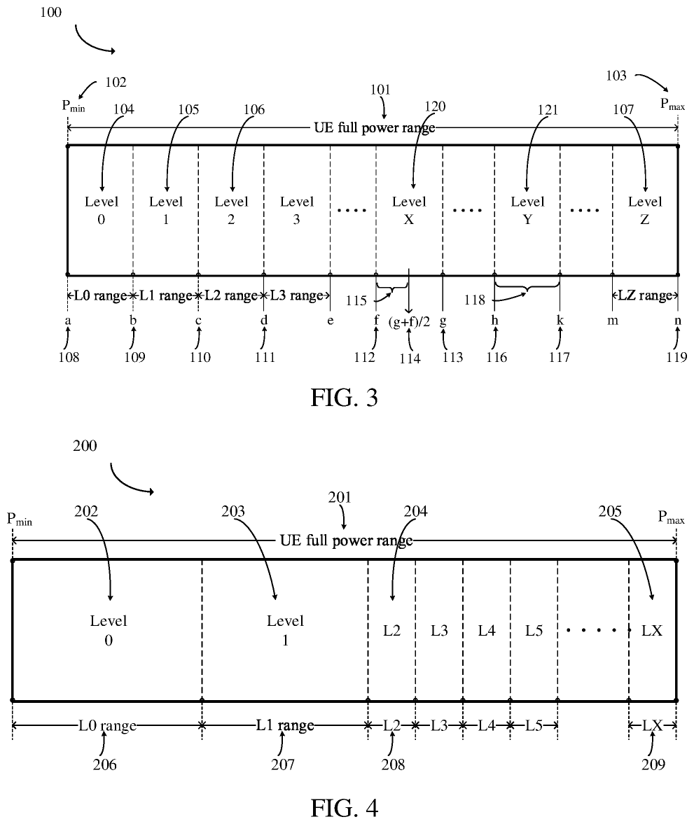

FIG. 3 is a schematic diagram of exemplary illustration of a set of sidelink Tx power levels according to an embodiment of the present disclosure. In details, a network configuration or pre-configuration of a set of quantized sidelink Tx power levels is illustrated in FIG. 3.

In some embodiments, FIG. 3 illustrates that, a first configuration of a set of Tx power levels which covers a full range of UE output power 101 from a Pmin value 102 to a Pmax value 103. The Pmin value 102 and the Pmax value 103 are respectively a minimum value and a maximum value of UE transmission power or power spectral density (PSD), which is a quantity/amount of power within a subcarrier, sub-channel, PRB or occupied frequency bandwidth of the associated transmission.

The Pmin value 102 can be zero but not necessarily has to be zero, or it can be based on value “a” 108 from the first configuration, where value “a” 108 is a starting value for the power range of level 0 104. The Pmax value can be based on the configured Pcmax (maximum allowable UE transmit power per carrier/cell), the pre-defined Ppowerclass (maximum allowable transmission power per UE output power class), or it can be based on value “n” 119 from the first configuration, where “n” 119 is the largest value for the power range of level Z 107 which is the highest level of UE Tx power within the first (pre-)configuration of a set of Tx power levels.

In some embodiments, according to conceptual illustration of the first configuration of a set of Tx power levels in diagram 100 of FIG. 3, UE full power range can be divided/quantized into plurality of Tx power levels, from the lowest range level 0 104, then level 1 105, level 2 106, and so on, to the highest range level Z 107. Each Tx power level represents a range of output power values, which is also known as quantization step size. That is, according to the diagram 100, Tx power range for level 0 104 is from value “a” 108 to “b” 109, level 1 105 is from value “b” 109 to “c” 110, level 2 106 is from “c” 110 to “d” 111, and so on, until the highest level Z 107. Correspondingly, the quantization step size for level 0 is “b-a”, level 1 is “c-b”, level 2 is “d-c”, and so on.

In some embodiments, each level has no overlapping range of transmission power with its adjacent power level(s), and therefore, each Tx power level has its own distinct range of output power values to avoid any confusion and misalignment of actual power used between the transmitter side and receiver side. Furthermore, quantization step size may not necessarily need to be equal for each Tx power level. That is, the quantization step size can be different to each other and the exact range of Tx power values for each step size is (pre-)configured to the UE as part of the first configuration.

One particular use case of using different quantization step size for UE Tx power is augmented reality (AR)/virtual reality (VR) group gaming application, where a group of users/UEs participating in the same game are usually confined within an indoor/outdoor space or a room. When SL communication is confined within an area, it is expected the operating range for UE output power is also confined within a certain range of UE's total power. It is then beneficial configuring UEs with a small quantization step size for the said certain operating power levels to provide better pathloss estimation accuracy, and a large step size for other power levels.

Additionally, there are several other reasons and scenarios where quantized Tx power levels having unequal step size can be beneficial for sidelink operations.

FIG. 4 is a schematic diagram of exemplary illustration of a set of sidelink Tx power levels according to an embodiment of the present disclosure. In details, exemplary illustration of UE's full power range being divided/quantized into multiple levels of Tx output power with smaller step size in the upper portion of UE's full power range is provided. In reference to diagram 200 in FIG. 4, UE's full power range 201 is unevenly divided/quantized into a set of X power levels, where level 0 202 and level 1 203 alone already occupy lower portion of the UE's full power range 201.

The remaining upper portion of the UE's full power range is divided/quantized into multiple smaller Tx power levels from level 2 204 to level X 205. It is also evidently clear that their respective range/step size of Tx power for L0 206 and L1 207 is much larger than L2 208 to LX 209. For this type of Tx power level quantization would be ideal for rural/open space and operating environments like freeway and highway areas where vehicles that are widely spaced and travelling at high speeds, and sidelink signal coverage reaches wide areas to ensure road safety. It is then likely for vehicle UEs to finely adjust their transmission output powers at the upper portion of UE full power range in to accommodate for variation in data packet size or travelling speed.

Furthermore, often in disaster events the required communication range should be large enough to cover as much area or as deeply as possible, since the emergency personnel are usually spread throughout the disaster zone including basement, high rise buildings and bush fires. In order to accommodate this type of operations, it is also beneficial to manage UE Tx output power in smaller granularity in the upper portion of UE full power range.

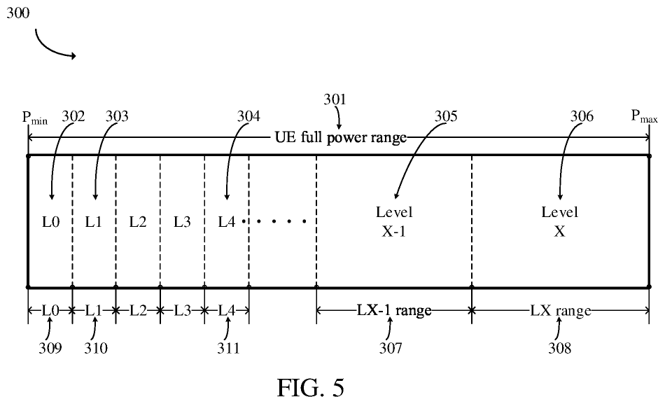

FIG. 5 is a schematic diagram of exemplary illustration of a set of sidelink Tx power levels according to an embodiment of the present disclosure. In details, exemplary illustration of UE's full power range being divided/quantized into multiple levels of Tx output power with larger step size in the upper portion of UE's full power range is provided.

In reference to diagram 300 in FIG. 5, this is another exemplary illustration of UE full power range 301 being unevenly divided/quantized into a set of X power levels, but this time UE's output power is managed in a reverse manner to the previous example illustrated in diagram 200 in FIG. 4.

In the depicted example 300, the lower portion of UE's full power range 301 is quantized into many Tx power levels (including 302, 303 to 304) with smaller step size/range of values per Tx power level 309, 310 to 311 than the upper portion levels (level X−1 in 305 and level X in 306) having bigger step size of 307 and 308. For this type of Tx power level quantization and management would be ideal for vehicle-to-everything (V2X) communication in urban, densely populated and slow-moving speed environment, where vehicles are closely spaced with short separation distance and sidelink signal coverage likely only need to reach limited distances. Other applications and use cases include SL unicast communication for UEs that are not far apart, AR/VR applications for portable UEs to save power consumption, and connectionless SL groupcast communication for UEs that are within the same geographical zone, where the zone size could be defined as small as 40×40 meters range. Therefore, it is more beneficial to manage UE Tx output power in finer granularity in the lower portion of UE full power range

In some embodiments, the first configuration of Tx power levels is a system wide or common (pre-)configuration that can be per cell, carrier or resource pool, such that the said first configuration is common for all UEs operating in the same area/environment.

Furthermore, Tx power level is to be directly signaled in SCI as a parameter field (in every SL transmission regardless of broadcast, unicast, or groupcast) and the bit size could be 6 bits to represent 64 levels, 5 bits to represent 32 levels, 4 bits to represent 16 levels, or 3 bits to represent 8 levels. With lesser number of bits to represent the full UE Tx power range, the step size would likely be larger than using more bits. As such, even though the Tx-UE determines its final Tx power to be in between two steps (e.g., 50/50 between two quantized levels), it will still indicate its Tx power level according to the (pre-)configuration.

In some embodiments, from a Rx-UE's perspective, there are two approaches that the UE can take when estimating the pathloss or determining the output power transmitted from the Tx-UE. The first approach is a safer approach whereby the Rx-UE assumes the Tx power used by the Tx-UE is in the middle of the indicated Tx power quantization step level. Therefore, the maximum estimation error when calculating pathloss is ½ the quantization step size.

In reference to diagram 100 in FIG. 3, when a Rx-UE decodes SCI and finds the indicated Tx power level is level X 120, based on the first configuration which is common to all UEs, the Rx-UE knows the actual Tx power used by the transmit UE would be somewhere between value “f” 112 and value “g” 113. By this safer approach, the Rx-UE will assume the Tx power used by the transmitter to be the mid-point between “f” and “g” 114, which can be mathematically expressed as (g+f)/2. Therefore, the maximum estimation error for the actual Tx power used will be 115, which is [(g+f)/2]−f.

In some embodiments, from a Rx-UE's perspective, the second approach is a more aggressive approach whereby the Rx-UE assumes the Tx power used is at the maximum value of the indicated Tx power quantization step level. As such, the Rx-UE will only likely to overestimate the pathloss and subsequently use a higher Tx power level for its own transmission of PSFCH and/or PSCCH/physical sidelink shared channel (PSSCH). This will, however, result in better link performance.

In reference to diagram 100 in FIG. 3, when a Rx-UE decodes SCI and finds the indicated Tx power level is Level Y 121, similar to the above, the said Rx-UE knows the actual Tx power used by the transmitting UE would be somewhere between value “h” 116 and “k” 117. By this more aggressive approach, the Rx-UE will assume the Tx power used by the transmitter is at the maximum value of this Tx power level, which is “k” 117. As such, the maximum estimation error for the actual Tx power used will be entire power range for level Y, which is k-h 118.

In some embodiments, innovative points include at least one of the following technical features. 1. (Pre-)configurability and including re-configurability of multi-level Tx power to flexibly manage UE's output power level that is suited for the application and service. 2. Variable quantization step size of Tx power, where the size of each step/Tx power range can be flexibly (pre-)configured and allows the network and system to put more emphasis (with smaller step size) on Tx power range where it is more important in order to adapt to the needs of different operating environment. 3. At the same time, the full range of UE Tx output power can still be represented with a smaller number of bits compared to the traditional representation method with a fixed and equal quantization steps. 4. Direct indication of Tx power level by the Tx-UE in SCI to mitigate the existing signaling exchange and processing delay deficiency issues.

In addition to the first configuration of a set of Tx power levels, a SL UE may be further configured with a second configuration for restricting the range of Tx power levels which can be used by the UE for SL communication. The restriction of UE output power can be confined within a specific range of Tx power level(s) from the first configuration, and it can be just one Tx power level representing a minimum or a maximum UE output power or a set/range of multiple levels that the UE is allowed to use for its SL transmission and indication in SCI.

Some target operating scenarios of configuring the second configuration for a UE to restrict its range of Tx power levels are SL unicast and groupcast communications to guarantee a certain level of quality of service (QoS) among a group of UEs while limiting their transmission interference to other SL and/or UL operations. One use case that could benefit from this second configuration of restricting UE transmission output level within a certain range of power is AR/VR gaming for a group of UEs. By setting a lower bound of the said range of Tx power level, it can guarantee a certain target bits-per-second (bps) throughput can be achieved for high data rate gaming applications. And at the same time an upper bound of Tx power level can be used to limit the coverage area as gaming among a group of UEs are always confined within a certain space, and thus to reduce power consumption for portable UE terminals.

In a scenario where only a minimum Tx power level is configured to a UE via the said second configuration, the main motivation would be to ensure a certain or minimum SL communication distance or coverage is reached. One use case that could benefit from this type of second configuration of restricting UE transmission output power to be always above a minimum level is V2X in vehicle platooning for a group of UEs.

In vehicle platooning as part of advanced V2X use cases, vehicles are traveling closely spaced in a line (one behind another) at high speed on a freeway or highway to save fuel. The leading car is usually the group header vehicle who manages and controls the platooning operation.

To ensure proper and smooth operation of platooning, all V2X communication between the platoon members should be received/hearable by the group header. As such, a minimum distance coverage should be applied to all group member UEs to account for the longest distance range within the group, which is from the last vehicle to the leading vehicle. Therefore, it is necessary to configured to all UEs within a vehicle platoon group a minimum Tx power level.

In a different scenario where only a maximum Tx power level is configured to a UE via the second configuration, some of its main purposes would be to limit transmission interference to surrounding SL and/or UL operations, and to improve SL resource reuse factor to accommodate more users in a system. One typical use case is to limit UE's transmission power for SL communication in or near a sensitive area such as hospital or an airport, where emergency and mission critical communications over SL and UL should be prioritized and protected from other transmissions.

Another use case is for a UE that is capable of dual radio access technology (RAT) communication between 4G-LTE and 5G-NR. By limiting the upper bound of SL transmission power for one RAT, the remaining power can be allocated for SL or UL transmission in another RAT.

The delivery of the second configuration can be performed/carried out using two mechanisms. The first mechanism is to deliver the second configuration directly from one UE to another over SL using PC5 radio resource control (RRC) configuration, e.g., from a group header UE for the purpose of Tx power management within a SL communication group. This can be used to limit SL communication range, minimize interference, improve frequency resource reuse and/or to ensuring a minimum coverage is maintained in unicast and groupcast links. And therefore, this mechanism is suitable and ideal for unicast and groupcast SL communications.

The second mechanism is to deliver the second configuration via network configuration or pre-configuration, e.g., for a specific SL resource pool or cell, and the configuration is common to all UEs. When the restriction of range of Tx power level is configured as being described as a second configuration for a UE under network configuration or pre-configuration, the restriction contents/parameters of the said second configuration can be delivered as part of the first configuration in the same configuration information element (IE) or in a separate/different configuration IE. Since this deliver mechanism is common for all UEs in a cell or resource pool, this mechanism is suitable and ideal for broadcast and groupcast SL communications.

In some embodiments, innovative points include at least one of the following technical features. 1. The use of second configuration to restrict the range of Tx output power from a UE for SL transmissions to limit its communication range, minimize interference, improve frequency resource reuse and/or to ensuring a minimum coverage is maintained. 2. The second configuration can be delivered directly over the sidelink interface using PC5 RRC configuration directly from one UE to another, as this can be particular useful for SL unicast and groupcast communications without network involvement (e.g., in out-of-network coverage operation).

In summary, in some embodiments, a sidelink (SL) transmit (Tx) power management and signaling method for a user equipment (UE) to indicate its transmission output power level intended for reception at other UEs is provided. The Tx-UE is to be firstly network configured (e.g., for in-network coverage operation) or pre-configured (e.g., for out-of-network coverage operation) with a first configuration of a set of Tx power levels, which covers a full range of UE output power from a minimum value (Pmin) to a maximum value (Pmax).

The Tx power indication from the Tx-UE could be used by a receiver UE (Rx-UE) for the purpose of calculating pathloss of the radio link between them and/or selecting appropriate SL resource(s) during its resource sensing and resource selection procedure, without having to rely on any channel measurement feedback in order to derive its own Tx power for sending information on the opposite direction. And the indication should be signaled directly over the 5th generation new radio (5G-NR) SL interface as part of sidelink control information (SCI), such that the Tx power information can be received and decoded by all Rx-UEs that are within the signal coverage range without needing to have a prior establishment of PC5 radio resource control (RRC) connection with the Tx-UE.

Commercial interests for some embodiments are as follows. 1. Less signaling message exchange will lead to reduced processing, delay, and power consumption. 2. More applications, use cases. and thus, greater flexibility. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product.

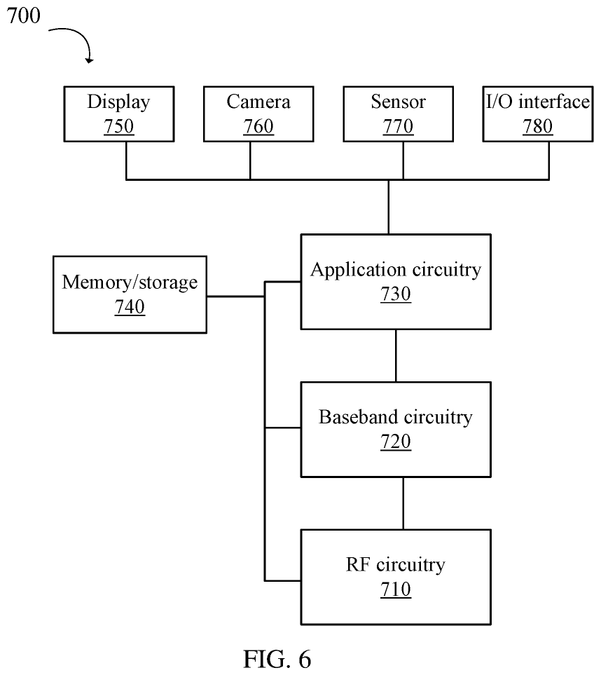

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc.

In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system.

User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system.

In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc.

In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product.

The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment for wireless communication, comprising:
a memory;
a transceiver; and
a processor coupled to the memory and the transceiver;
wherein the processor is configured to:
be configured with a first configuration of a set of transmit (Tx) power levels; and
control the transceiver to transmit, to another user equipment, one of Tx power levels from the first configuration of the set of Tx power levels, wherein the set of Tx power levels provides a full range of output power for the user equipment.

2. The user equipment of claim 1, wherein the first configuration of the set of Tx power levels is network configured or pre-configured.

3. The user equipment of claim 1, wherein a number of Tx power levels is flexibly configured to represent the full range of output power allowed for the user equipment.

4. The user equipment of claim 1, wherein a range of output power value per Tx power level is flexibly configured.

5. The user equipment of claim 1, wherein the one of the Tx power levels from the first configuration of the set of Tx power levels is provided as part of sidelink control information (SCI) from the transceiver to the another user equipment.

6. The user equipment of claim 1, wherein the processor is configured to be configured with a second configuration to restrict the set of Tx power levels, and the transceiver is configured to transmit, to the another user equipment, the second configuration.

7. The user equipment of claim 6, wherein the second configuration is confined within a specific range of Tx power levels from the first configuration.

8. The user equipment of claim 6, wherein the second configuration is one of a specific set of Tx power levels, a specific range of Tx power levels, a minimum level of Tx power levels, and a maximum level of Tx power levels.

9. The user equipment of claim 6, wherein the second configuration is network configured or pre-configured.

10. The user equipment of claim 6, wherein the second configuration is provided via a radio resource control (RRC) signaling from the transceiver to the another user equipment.

11. The user equipment of claim 9, wherein when the first configuration and the second configuration are network configured or pre-configured, the second configuration is provided together with the first configuration via a same information element (IE) or separate from the first configuration via a different IE.

12. A method of wireless communication of a user equipment, comprising:
being configured with a first configuration of a set of transmit (Tx) power levels; and
transmitting, to another user equipment, one of Tx power levels from the first configuration of the set of Tx power levels, wherein the set of Tx power levels provides a full range of output power for the user equipment.

13. The method of claim 12, wherein a number of Tx power levels is flexibly configured to represent the full range of output power allowed for the user equipment, and a range of output power value per Tx power level is flexibly configured.

14. The method of claim 12, wherein the one of the Tx power levels from the first configuration of the set of Tx power levels is provided as part of sidelink control information (SCI) from the user equipment to the another user equipment.

15. The method of claim 12, further comprising being configured with a second configuration to restrict the set of Tx power levels and transmitting, to the another user equipment, the second configuration.

16. The method of claim 15, wherein the second configuration is confined within a specific range of Tx power levels from the first configuration.

17. The method of claim 15, wherein the second configuration is one of a specific set of Tx power levels, a specific range of Tx power levels, a minimum level of Tx power levels, and a maximum level of Tx power levels.

18. The method of claim 15, wherein the second configuration is provided via a radio resource control (RRC) signaling from the user equipment to the another user equipment.

19. The method of claim 15, wherein when the first configuration and the second configuration are network configured or pre-configured, the second configuration is provided together with the first configuration via a same information element (IE) or separate from the first configuration via a different IE.

20. A terminal device, comprising: a processor and a memory configured to store a computer program, the processor configured to execute the computer program stored in the memory to perform the method of any one of claim 12.
